(19) United States
(12) Patent Application Publication
(10) Pub. No.: US 2014/0295369 A1
(43) Pub. Date: Oct. 2, 2014

(54) Orthodontic Accessory

(71) Applicant: Celestino José Prudente NÓBREGA, Pindamonhangaba (BR)

(72) Inventor: Celestino José Prudente NÓBREGA, Pindamonhangaba (BR)

(21) Appl. No.: 13/933,436

(22) Filed: Jul. 2, 2013

(30) Foreign Application Priority Data
Mar. 26, 2013 (BR) 20 2013 007004 7

(51) Int. Cl. A61C 7/28

(52) U.S. Cl. CPC A61C 7/28
USPC 433/10

(57) ABSTRACT

The present invention relates to an orthodontic accessory (1) having a fixing base (2), which has a support (3) with a slot (31) for an orthodontic wire (7), the slot (31) comprises a cover (4); and a clip (6) attached to the support (3), transversely to the slot (31).

### FIELD OF THE INVENTION

The present invention relates to an orthodontic accessory, particularly a bracket or tube, used as accessories of orthodontic appliances serving as support and guide with slots for placing wires or orthodontic archwires.

### BACKGROUND OF THE INVENTION

Orthodontic appliances are known by those person skilled in the art, which are used in dentistry, specifically in the field of orthodontics, for dental malocclusions correction.

The fixed appliances comprise some elements, such as wires or archwires, and accessories thereof: brackets, tubes, band and elastic ligatures.

Particularly, the bracket and the tube are parts bonded directly at the tooth enamel or welded to the orthodontic band. They hold the wires and rubber bands, by which the orthodontist employs the force required for teeth correction. The brackets are applied to incisors, canines and pre-molars (upper and lower); and the tubes are applied to molars (upper and lower).

The wires or orthodontic archwires used have a varying cross-section, such as circular or rectangular; and their compositions also vary, which can be made of steel, nickel-titanium, titanium-molybdenum, etc. The force required for moving teeth during the orthodontic treatment is originated from the flexibility of the orthodontic wires (archwires), which are positioned in the slots of the accessories. The archwires can act by their own flexibility or by bends performed in orthodontic archwires.

The orthodontic archwires are attached to the slots of accessories, which can be classified as:

a) Conventional accessories: for engaging orthodontic archwires with the brackets or tubes, an interlocking system is needed, which can be represented by metal wires or elastomeric ligatures;

b) Self-ligating accessories: they do not need the use of interlocking systems, and can be classified according to the activity of the clips or hooks that replace the interlocking systems:
Interactive self-ligating accessories: have flexible clips or hooks that force the orthodontic archwires toward the bottom of the slot of the bracket or tube.
Passive self-ligating accessories: have rigid clips or hooks that do not force the orthodontic archwires toward the bottom of the slot of the bracket or tube.

Each interactive or passive self-ligating accessory model has a specific clinical advantage, and hence, each one is used in a particular stage of orthodontic treatment.

The passive model does not provide interaction between the clip or hook with the orthodontic archwire, the friction coefficient between the accessory and the archwire is significantly reduced, making the initial stage of treatment easy where very flexible wires of circular cross-section are used, thus providing control and quickness for positioning the teeth crowns.

The interactive model is used at intermediate and final stages of treatment, when the use of rectangular cross-section archwire is important, which should closely touch the slot walls of the accessories, providing a perfect control over the positioning of teeth roots.

It can be cited as an example of the prior art the patent MU8600020-9, which discloses a conventional orthodontic accessory of low friction, where upper and lower side projections are introduced that allow the placement of conventional elastic ligatures on such projections, without pressing the orthodontic archwires against the bottom of the slot or groove of the accessory. Thus, this orthodontic accessory is used in the initial stage of treatment.

The accessory disclosed in PI0514844-8 can be cited as an example of orthodontic accessory with interactive function, which aims to include a coloring means for coloring. The orthodontic accessory of this document comprises a binding cover pivotally connected to the accessory base, which can be moved between an opened position and a closed position relative to the slot or groove, which accommodates the orthodontic wire, keeping it in the groove when it is in the closed position.

Neither these documents nor the currently marketed accessories allow both passive and interactive functions in the same object.

It happens that the use of an accessory of interactive function at an early stage of treatment is not recommended, since the use of an interactive accessory with rectangular wires will cause an excessive friction on the orthodontic wire/accessory interface, and consequently, the molars shall present, at the end of this stage, a root position that could impair their movement, which will be firmly set, with roots “anchored” in the cortical bone.

On the other hand, if passive accessories are used during the intermediate and final stages, there will be a low friction coefficient on the orthodontic wire/accessory interface. Therefore, there will be no proper root positioning, and hence, the quality of the treatment could be impaired, with high possibility of relapse.

Yet another disadvantage of some self-ligating accessories of the prior art comprises stainless steel alloy clips, which may be irreversibly deformed over time, especially during the opening movement of clips, where the practitioner inadvertently and improperly inserts the opening instrument (angled).

Thus, until now, the self-ligating accessories available to the orthodontist can only act in a passive or interactive manner.

In order to solve the state of the art problems, the present utility model was developed, which comprises an orthodontic accessory that can be used either passively or interactively mode, without need to exchange.

### SUMMARY OF THE INVENTION

The orthodontic accessory of the present invention can be considered as a hybrid accessory, once it can be used in passive mode, at the beginning of the treatment, where the low friction coefficient brings speed, comfort and control over the positioning of crowns. When the treatment reaches the intermediate stage, and up to the final stage, the accessory can be converted to the interactive mode, bringing all the biomechanical benefits inherent to the control of optimum root positioning.

This orthodontic accessory is self-ligating and is the only one that can behave as either passive or interactive, allowing the orthodontist to choose the operating mode in accordance with the clinical need of the moment.

Preferably, the present orthodontic accessory has a clip consisting of a nickel-titanium alloy, which is biocompatible and has 100% of shape memory, and does not deform throughout the treatment, as it is the case of interactive self-ligating accessories available on the market.

Another advantage of the orthodontic accessory of the present invention is that it has a recess, which automatically directs and drives the sliding of a sharp instrument during the opening or removing procedure of the clip, facilitating its movement.

Schematic figures of an embodiment of the present orthodontic accessory are presented below, whose dimensions and proportions are not necessarily represented in real scale, since the figures have only the purpose to teach the various aspects of this utility model, whose scope of protection is set forth only by the scope of the attached claims.

### BRIEF DESCRIPTION OF THE DRAWINGS

FIG. 1 illustrates an angled front perspective view of the orthodontic accessory (1) of the present utility model.

FIG. 2 illustrates a lateral (proximal) view of the orthodontic accessory (1).

FIG. 3 illustrates a front view of the orthodontic accessory (1).

FIG. 4 illustrates a perspective view of the orthodontic accessory (1) with its clip (6) being removed by an instrument (8) inserted into the opening hole (62).

FIG. 5 illustrates a perspective view of the orthodontic accessory (1) with the clip (6) separated.

FIG. 6 illustrates a perspective view of the orthodontic accessory (1) with the cover (4) being withdrawn with an instrument (8) inserted in the slot (31).

FIG. 7 illustrates a perspective view of the orthodontic accessory (1) without the wire (7) cover (4).

FIG. 8 illustrates a perspective view of the orthodontic accessory (1) without the cover (4), with the wire (7) positioned on the slot (31).

FIG. 9 illustrates a perspective view of the orthodontic accessory (1) without the cover (4), with the wire (7) positioned on the slot (31) and with the clip (6) set back in the accessory (1).

FIG. 10 illustrates a lateral (proximal) view of the orthodontic accessory (1) illustrated in FIG. 9.

### DETAILED DESCRIPTION OF THE INVENTION

As it is illustrated in the attached figures, the present utility model relates to an orthodontic accessory (1) comprising a fixing base (2) at a dental surface (not illustrated), which has a support (3) to a wire or orthodontic archwire (7).

Said support (3) is provided with a slot (31) for positioning said wire (7); side wings (32) on the slot (31) useful for positioning the retention elastic ligatures (not illustrated) of the wire (7); and a hook (5) to receive elastic ligatures that advance from an orthodontic accessory (1) positioned on an upper tooth (not shown) to other orthodontic accessory (1) positioned on a lower tooth (not shown).

Said orthodontic accessory (1) also comprises a cover (4) for the slot (31), closing the wire (7) inside the slot.

The orthodontic accessory (1) further has a “C” cross-section clip (6), which is coupled to the support (3), transversely to the slot (31), by fitting its flaps (61), one above and the other below the slot (31), involving it.

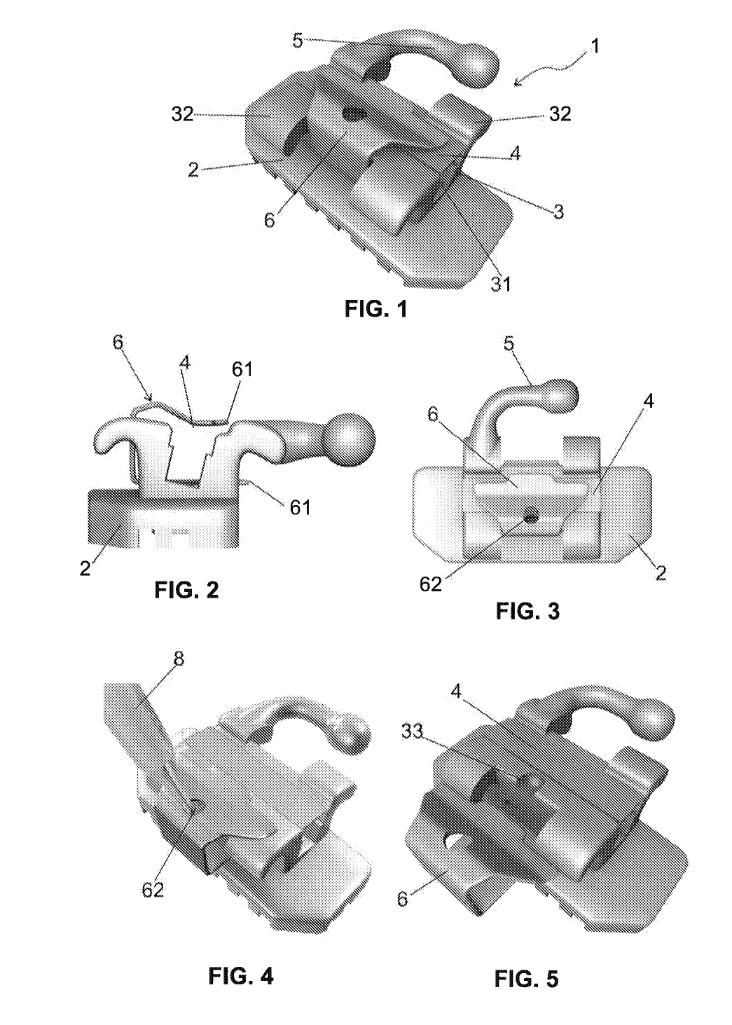

In the embodiment illustrated in FIGS. 1-3, there is a cover (4) closing the slot (31) and the clip (6) fitted in the accessory (1), keeping the wire (7) (not shown in these figures) in the slot (31), without contacting the clip (6), which presses the cover (4) against the support (3). In this embodiment of use, the friction on the wire (7) is reduced, and the accessory (1) is properly used in the initial stage of treatment.

As shown in FIGS. 9 and 10, the accessory (1) is without the cover (4), and hence, the clip (6) has direct contact with the wire (7), pressing it against the slot (31). This interaction between the wire/accessory enables the use of the accessory (1) in the intermediate and final stages, which is the same used in the initial stage, and thus, it does not require any accessory exchange (1).

In other words, this constructive disposition allows many forms of use of the orthodontic accessory (1). It can be used conventionally without the clip (6) and without the cover (4) using elastic ligatures; with the clip (6) and without the cover, retaining the wire (7) inside the slot (as shown in FIGS. 9 and 10); and, with the clip (6) and the cover (4), when the wire (7) is confined in the slot (31), but without the clip (6) pressure that compresses the cover (4) on the edges of the slot (31) (see FIGS. 1, 2 and 3), retaining it in the orthodontic accessory (1).

This way, the present orthodontic accessory (1) may be used during the whole orthodontic treatment without needing to exchange it. That is:
in the initial stage, when the orthodontic apparatus is used with lower resistance to wire engagement (see FIGS. 1 to 3); and,
in the intermediate and final stage, in which there is an interaction between the orthodontic accessory (1) and the wire (7) (see FIGS. 9 and 10).

Particularly, the clip (6) comprises an opening hole (62) on its upper face away from the edges of the flaps (61), which allows the fitting of a sharp instrument (8), which makes the clip (6) removal easier when leveraging against the support (3) of the wire (7) (see FIG. 4).

In this particular situation, there is also a recess (33) on the top edge of the slot (31) aligned with the opening hole (62), which orients the positioning of said instrument (8) when removing the clip (6), as it is illustrated in FIG. 4.

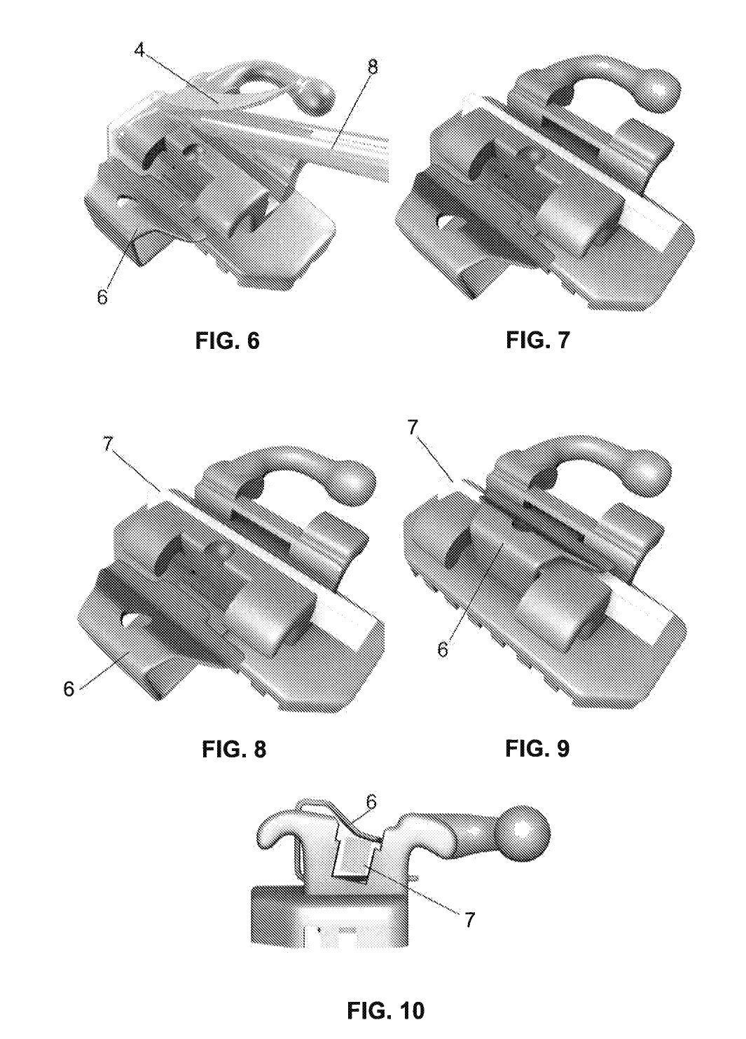

After removing the clip (6), the withdrawal of the cover (4) becomes easier which, with the same instrument (8) introduced in the slot (31), leverages against the slot base (31), pushing out the cover, as it is schematically shown in FIG. 6.

Those skilled in the art will readily realize, from the description and the drawings shown, many equivalent forms for carrying out the invention to achieve the same result, in which case they are covered by the attached claims.

1- An orthodontic accessory, having a fixing base on a tooth, from which there is a support with a slot for a wire or orthodontic archwire, the orthodontic accessory being characterized by comprising a cover to the slot; and a “C” cross-section clip, which is coupled to the support, transversely to the slot, by fitting its flaps, one above and the other below the slot, in order to involve it.

2- The orthodontic accessory, according to claim 1, wherein the clip comprises an opening hole on its upper face away from the edges of the flaps, for fitting an instrument when removing the clip.

3- The orthodontic accessory, according to claim 2, further comprising recess on the top edge of the slot aligned with the opening hole.
